(19) United States
(12) Patent Application Publication
(10) Pub. No.: US 2014/0224379 A1
(43) Pub. Date: Aug. 14, 2014

(54) FILLING OF STORAGE CONTAINERS WITH A GASEOUS PRESSURISED MEDIUM

(71) Applicants: Robert Adler, Gerasdorf (AT); Sascha Domer, Wien (AT); Georg Siebert, Wien (AT)

(72) Inventors: Robert Adler, Gerasdorf (AT); Sascha Domer, Wien (AT); Georg Siebert, Wien (AT)

(21) Appl. No.: 14/171,867

(22) Filed: Feb. 4, 2014

(30) Foreign Application Priority Data
Feb. 12, 2013 (DE) 102013002431.5

(51) Int. Cl. F17C 5/06

(52) U.S. Cl. CPC F17C 5/06
USPC 141/4

(57) ABSTRACT

The invention relates to a method for refuelling a storage container with a pressurised gaseous medium, in particular hydrogen, wherein this medium is introduced into the storage container via a tank supply line, wherein the temperature of the medium upon entry into the storage container and the pressure in the storage container are controlled in such a way that the enthalpy of the medium introduced into the storage container fluctuates within a preset enthalpy range or is constant.

### CROSS REFERENCE TO RELATED APPLICATIONS

This application claims priority from German patent application DE 102013002431.5 filed Feb. 12, 2013.

### BACKGROUND OF THE INVENTION

The invention relates to a method for filling a storage container with a pressurised gaseous medium, in particular hydrogen.

For the refuelling of vehicles with gaseous hydrogen as a fuel, specially designed filling stations are required, which meet technical and safety requirements essential for the refuelling. Thus, for example, provision can be made such that the hydrogen is intended to be conveyed within three minutes into a storage container designed for the purpose (e.g. vehicle tank) and brought to a pressure of 700 bar, without the temperature in the storage container thereby rising over 85° C. and without the temperature of the hydrogen falling below −40° C.

Before the start of the refuelling procedure, a pressure and tightness test is usually carried out (e.g. according to standard SAE 2601), wherein the pressure in the storage container is determined and the tightness of the connected tank supply line and of the storage container is checked, The actual refuelling then begins, during which a pressure ramp is passed through for the refuelling of the storage container, usually by means of a ramp regulator. The precise pressure and the precise temperature after the refuelling procedure can only be determined relatively imprecisely with this kind of refuelling, especially when the storage container is relatively empty at the start of the refuelling procedure. In order that the hydrogen does not assume a temperature above 85° C. along said ramp (the temperature also increases due to the increasing pressure in the storage container), the hydrogen has to be cooled to a temperature range of −33° C. to −40° C. within a specific time period. The cooling system required for this necessitates a relatively large amount of installation space and energy, which depending on the arrangement in the filling station can have an unfavourable effect on costs and also on the susceptibility of the cooling system to damage.

Since hydrogen continuously flows through such a cooling system while said pressure ramp is being passed through, such cooling systems have to operate with a relatively high temperature reduction in order to bring about the desired cooling of the hydrogen at the filling station, which adversely impacts on the energy consumption of this cooling system.

Proceeding from this, therefore, the problem underlying the present invention is to make available a method which increases the efficiency of the cooling system and permits a better determination of the temperature and the pressure in the storage container after the refuelling procedure.

### SUMMARY OF THE INVENTION

Accordingly, provision is made such that, with the method according to the invention for refuelling a storage container, in particular in the form of a vehicle tank, with a pressurised gaseous medium, in particular hydrogen, this medium is introduced into the storage container via a tank supply line, wherein the temperature of the medium upon entry or shortly before entry into the storage container and the pressure in the storage container are controlled in such a way that the enthalpy or a magnitude of the medium introduced into the storage container proportional thereto fluctuates within a preset enthalpy range or ideally is constant.

As is known, the enthalpy H=U+pV is the sum of the internal energy U of the considered medium and the volume work pV that must be performed against pressure p in order to generate volume V, which is occupied by the system in the considered state. For an isenthalpic process, i.e. a process with constant enthalpy, dH=dU+Vdp=0 applies.

With the method according to the invention, provision is preferably made such that, during refuelling, the relative fluctuation of the enthalpy is less than 20%, preferably less than 10%, particularly preferably less than 5%, particularly preferably less than 1%.

According to a further preferred embodiment of the invention, provision is made such that the temperature of the hydrogen upon entry into the storage container and the pressure in the storage container are controlled by introducing a suitably temperature-regulated mass flow of said medium into the storage container, in such a way that the enthalpy or a magnitude of the medium introduced into the storage container proportional thereto fluctuates back and forth, wherein in particular the enthalpy fluctuates more or less periodically back and forth or fluctuates around a constant enthalpy value.

With the method according to the invention, a volume of the tank supply line coolable by means of a heat transfer medium is preferably filled with the medium, in such a way that the pressure prevailing in the heat transfer medium is greater than the pressure prevailing in the storage container, wherein the medium present in the volume is cooled by the heat transfer medium, so that heat arising in particular with the compression of the medium in the volume is discharged by means of the heat transfer medium, and wherein the medium present in the volume is relieved of pressure by means of a throttle provided downstream of the volume and is drained into the storage container (this process is also referred to as pulsation), in such a way that the pressure and the temperature of the medium in the storage container increase and therefore the enthalpy of the medium in the storage container increases by a certain amount, wherein the temperature of the medium still present in the volume falls as a result of the pressure relief, so that the medium subsequently flowing out of the volume into the storage container cools the medium present in the storage container and the enthalpy of the medium in the storage container falls again.

In a further variant of the method according to the invention, provision is made such that a further volume of the tank supply line coolable by means of a further heat transfer medium is pre-filled with the medium, so that—as before—the pressure prevailing in the further heat transfer medium is greater than the pressure prevailing in the storage container, wherein the medium present in the further volume is cooled by means of the further heat transfer medium, so that heat arising in particular with the compression of the medium in the further volume is discharged by means of the further heat transfer medium, and wherein the medium present in the further volume is relieved of pressure by means of a throttle provided downstream of the further volume and is drained into the storage container in such a way that the pressure and the temperature of the medium in the storage container increase and therefore the enthalpy of the medium in the storage container increases, and wherein the temperature of the medium still present in the further volume falls as a result of the pressure relief, so that the medium subsequently flowing out of the volume into the storage container cools the medium present in the storage container and the enthalpy of the medium in the storage container falls again.

The medium pre-filled into the one volume is preferably drained into the storage container with a time lag with respect to the medium pre-filled into the further volume,

This process—pre-filling of the volume or volumes and draining of the medium via of the throttle into the storage container—is preferably carried out repeatedly for the refuelling of the storage container, so that the enthalpy fluctuates or oscillates back and forth essentially in said enthalpy range.

The heat transfer medium or media preferably each comprise a thermoblock made of metal, in particular of aluminium (so-called “aluminium cold fill”), which surrounds or constitutes a section, more precisely said volume, of the tank supply line, wherein the thermoblock is preferably cooled by means of a cooling circuit, in which a cooling medium for example circulates.

Furthermore, said throttle can be controlled in such a way that said pulsation is improved in the at least one heat transfer medium, i.e. that the enthalpy range is reduced. In other words, the filling process thus approaches an ideal isenthalpic process. The method can of course also be carried out with a fixed throttle.

As a result, the final temperature of the filling procedure, i.e. of the medium, can be better determined using the method according to the invention, and more precisely by calculating an isenthalpic filling; the previously employed polytopic filling is replaced by an isenthalpic one. Especially in the critical area (filling of an empty vehicle tank), the precision can be increased enormously on account of the isenthalpic filling instead of an isentropic filling.

Furthermore, the cooling efficiency is also increased by the enthalpy-dependent pulsation in the at least one heat transfer medium. It is thus possible to work with a smaller temperature gradient between the cooling media.

### BRIEF DESCRIPTION OF THE DRAWINGS

Further details and advantages of the invention will be explained by the following descriptions of the figures of examples of embodiment with the aid of the figures.

In the figures:

FIG. 1 shows a diagrammatic representation of a refuelling facility for the ideally isenthalpic refuelling of a storage container (e.g. vehicle tank) with hydrogen; and

FIG. 2 shows an exemplary curve of the temperature and the enthalpy of the hydrogen in the storage container (e.g. vehicle tank) during refuelling of the storage container with hydrogen according to the invention.

### DETAILED DESCRIPTION OF THE INVENTION

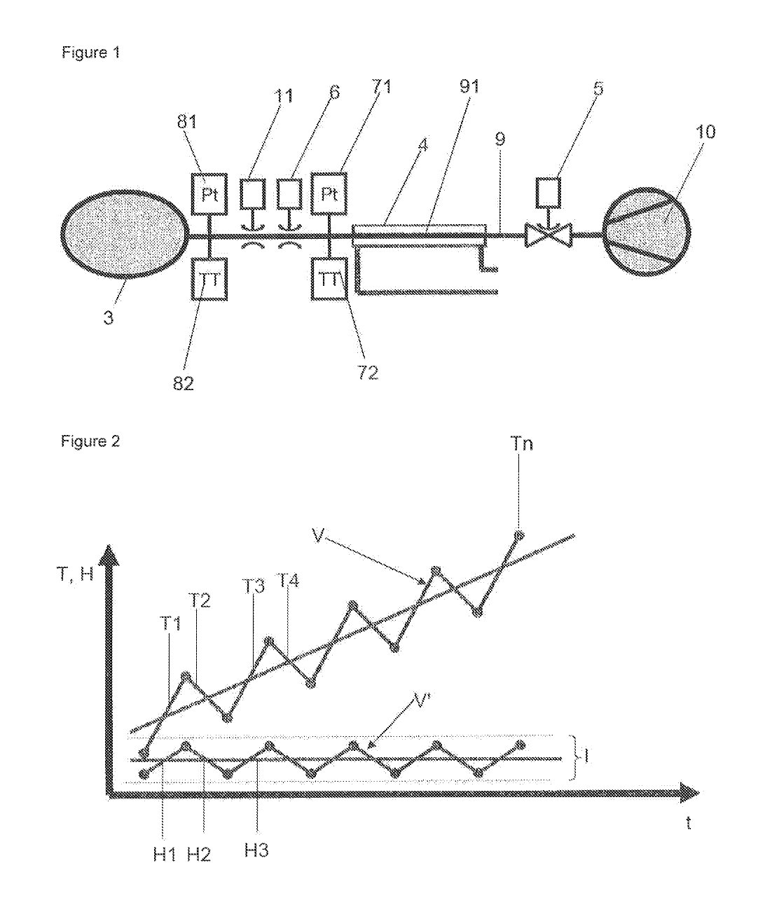

FIG. 1 shows a refuelling facility 1 for refuelling a storage container 3 in the form of a vehicle tank which can be connected to a tank supply line 9. Hydrogen is conveyed via a compressor 10 and a controllable valve 5 disposed downstream of compressor 10 into a first heat transfer medium 4, which cools a section or a known volume 91 of tank supply line 9. Heat transfer medium 4 is preferably formed by a thermoblock, which surrounds or constitutes said volume 91 of tank supply line 9 and is cooled by means of a cooling circuit. The thermoblock is preferably made of aluminium (so-called aluminium cold fill). The hydrogen is cooled to a specific temperature by means of heat transfer medium 4. Provided downstream of heat transfer medium 4 is a pressure sensor and a temperature sensor 71, 72, which ascertain the pressure and respectively the temperature of the hydrogen upstream of an, in particular, controllable throttle 6. Disposed downstream of throttle 6 is a mass flow measuring unit 11, which serves to detect the mass flow of the hydrogen conveyed into storage container 3. Also provided downstream of mass flow measuring unit 11 on tank supply line 9 is a further pressure sensor and a further temperature sensor 81, 82, with which the pressure in storage container 3 and the temperature of the hydrogen introduced into storage container 3 can be detected. It is ascertained from the measured values of sensors 71, 72, 81, 82 and unit 11 how, in particular, the mass flow, the pressure and the temperature of the hydrogen must be conditioned, in order that the refuelling essentially runs in an isenthalpic manner, i.e. the enthalpy of the hydrogen fluctuates within a preset enthalpy range I during refuelling.

Such a refuelling procedure according to the invention is shown in FIG. 2 by way of example with the aid of a qualitative temperature curve V of temperature T of the hydrogen introduced into storage container 3, said temperature being measured by temperature sensor 81, as well as a qualitative curve V′ of the enthalpy of the hydrogen filled into storage container 3. Temperature T and enthalpy H are plotted on the ordinate in arbitrary units and time t on the abscissa, The periodic increase in temperature T in storage container 3 arises through the variation of the pressure of the hydrogen with which storage container 3 is refuelled. For the purpose of comparison, the straight continuous line represents a hypothetical average temperature curve.

For the refuelling of storage container 3, a defined quantity of hydrogen is supplied via valve 5 into volume 91 of heat transfer medium 4 and is pre-cooled there to an initial temperature. On account of throttle 6, the initial pressure of the hydrogen in volume 91 lies above that of storage container 3. The hydrogen is then conveyed via throttle 6 into storage container 3, so that a defined temperature increase T1 is produced in storage container 3, which in turn leads to an increase H1 in the enthalpy, As a result of the hydrogen flowing into storage container 3, the pressure and the temperature of the hydrogen in volume 91 of heat transfer medium 4 fall, which leads to an afterflow of colder hydrogen at a lower pressure from heat transfer medium 4, or volume 91, via throttle 6 into storage container 3, in such a way that temperature T2 of the hydrogen and enthalpy H2 in storage container 3 fall again. The procedure is controlled in such a way that the enthalpy fluctuates in a preset enthalpy range I.

A further compression of volume 91 of heat transfer medium 4 via valve 5 leads to a renewed pressure and temperature increase in heat transfer medium 4 (the temperature increase arises primarily due to the increasing pressure), wherein heat transfer medium 4 in turn immediately removes the compression-related heat from the hydrogen, so that the hydrogen cools down. Proceeding from this temperature established in heat transfer medium 4, the hydrogen is in turn conveyed via throttle 6 into storage tank 3, which in turn leads to an increase in temperature T3 in the storage container and an associated enthalpy increase H3 in storage tank 3, but this time under raised pressure conditions. As a result of the hydrogen flowing out of heat transfer medium 4 or volume 91 and the associated drop in pressure, the hydrogen still present in volume 91 cools down, which in turn leads to an afterflow of colder hydrogen out of heat transfer medium 4 into storage container 3 (at T4), This procedure is repeated until a desired pressure and a desired temperature Tn is reached, so that a defined pressure and a defined temperature Tn prevail in storage container 3 at the end of the refuelling procedure. It is particularly important with this method that the enthalpy in storage container 3 ideally remains constant or fluctuates within said range in the course of the refuelling procedure by means of this type of refuelling.

In order to keep fluctuation range I as small as possible, it may be useful to constitute the throttling of the hydrogen into storage container 3 in a variable manner by means of throttle 6, i.e. to control the mass flow of the hydrogen by means of throttle 6. A further measure for reducing fluctuation range I and for more rapid execution of the method according to the invention is the use of a further heat transfer medium connected in parallel, which is preferably operated anti-cyclically with respect to heat transfer medium 4, i.e. the subsequent filling, cooling and outflow periods of the one heat transfer medium 4 described above take place with a time lag in the further heat transfer medium.

In order to be able to monitor the heat input into storage container 3, it is in particular necessary to detect the mass flow into storage container 3. This takes place in particular by means of a mass flow measuring device 11. The profile of temperature curve V and enthalpy curve V′ may be characterised in the actual operation, in particular, by rounded, harmonic (e.g. sinusoidal) fluctuations.

The cooling of the hydrogen as a result of the described pressure drop in volume 91 of heat transfer medium 4 and, as the case may be, also in the further heat transfer medium also contributes to the cooling of the hydrogen, which in particular ensures energy-saving refuelling of storage container 4 compared to the prior art, which provides a constant pressure or mass ramp. It should be noted that the temperature drop as a result of the pressure drop in heat exchanger 4 and, as the case may be, the further heat exchanger is determined by the given volume 91; the smaller volume 91, the greater the temperature drop.

### LIST OF REFERENCE NUMBERS

| | |
|---|---|
| 1 | Refuelling facility |
| 3 | Storage container |
| 4 | Heat transfer medium |
| 5 | Valve |
| 6 | Throttle |
| 71 | Pressure sensor |
| 72 | Temperature sensor |
| 81 | Pressure sensor |
| 82 | Temperature sensor |
| 9 | Tank supply line |
| 91 | Volume |
| 10 | Compressor |
| 11 | Mass flow measuring unit |
| H1, H3 | Enthalpy increase |
| H2 | Enthalpy degrease |
| V | Time-related temperature curve |
| V′ | Time-related enthalpy curve |
| T1, T3 | Temperature increase |
| T2, T4 | Temperature decrease |
| I | Enthalpy range |

What we claim is:

1. A method for refuelling a storage container with a pressurised gaseous medium, wherein this medium is introduced into the storage container via a tank supply line, wherein the temperature of the medium upon entry into the storage container and the pressure in the storage container are controlled in such a way that the enthalpy or a magnitude of the medium introduced into the storage container proportional thereto fluctuates within a preset enthalpy range or is constant.

2. The method according to claim 1, characterised in that the pressurized gaseous medium is hydrogen.

3. The method according to claim 1, characterised in that the relative fluctuation of the enthalpy during refuelling is less than 20%.

4. The method according to claim 1, characterised in that the relative fluctuation of the enthalpy during refueling is less than 10%.

5. The method according to claim 1, characterised in that the relative fluctuation of the enthalpy during refueling is less than 5%.

6. The method according to claim 1, characterised in that the relative fluctuation of the enthalpy during refueling is less than 1%.

7. The method according to claim 1, characterised in that the temperature of the medium upon entry into the storage container and the pressure in the storage container are controlled in such a way that the enthalpy or the magnitude of the medium introduced into the storage container proportional thereto fluctuates back and forth in the enthalpy range.

8. The method according to claim 7, characterized in that the fluctuation is periodic.

9. The method according to claim 1, characterised in that a volume of the tank supply line coolable by means of a heat transfer medium is pre-filled with the medium, so that the pressure prevailing in the heat transfer medium is greater than the pressure prevailing in the storage container, wherein the medium present in the volume is cooled by the heat transfer medium, and wherein the medium present in the volume is relieved of pressure by means of a throttle provided downstream of the volume and is drained into the storage container, in such a way that the pressure and the temperature of the medium in the storage container increase and the enthalpy of the medium in the storage container increases, and wherein the temperature of the medium still present in the volume falls due to the pressure relief, so that the medium subsequently flowing out of the volume into the storage container cools the medium present in the storage container and the enthalpy of the medium in the storage container falls again.

10. The method according to claim 9, characterised in that a further volume of the tank supply line coolable by means of a further heat transfer medium is pre-filled with the medium, so that the pressure prevailing in the heat transfer medium is greater than the pressure prevailing in the storage container, wherein the medium present in the further volume is cooled by the further heat transfer medium, and wherein the medium present in the further volume is relieved of pressure by means of the throttle and is drained into the storage container, in such a way that the pressure and the temperature of the medium in the storage container increase and the enthalpy of the medium in the storage container increases, and wherein the temperature of the medium still present in the further volume falls due to the pressure relief, so that the medium subsequently flowing out of the further volume into the storage container cools the medium present in the storage container and the enthalpy of the medium in the storage container falls again.

11. The method according to claim 10, characterised in that the medium pre-filled into the one volume is drained into the storage container with a time lag with respect to the medium pre-filled into the further volume.

12. The method according to claim 11, characterised in that the one and/or the further volume is pre-filled repeatedly with the medium for the refuelling of the storage container and the medium is drained in each case via the throttle into the storage container.
